(19) United States
(12) Patent Application Publication
(10) Pub. No.: US 2014/0198426 A1
(43) Pub. Date: Jul. 17, 2014

(54) IN DUCT IONIZATION SYSTEM WITH A TRANSFORMER THAT IS SPACED FROM THE IONIZATION TUBE

(71) Applicant: Anthony M. Abate, Seymour, CT (US)

(72) Inventor: Anthony M. Abate, Seymour, CT (US)

(73) Assignee: CLEAN AIR GROUP, INC., Fairfield, CT (US)

(21) Appl. No.: 14/343,454

(22) PCT Filed: Aug. 29, 2012
(86) PCT No.: PCT/US12/52800

§ 371 Date: Mar. 7, 2014

Related U.S. Application Data
(60) Provisional application No. 61/532,185, filed on Sep. 8, 2011.

(51) Int. Cl. B03C 3/38; F24F 3/16

(52) U.S. Cl. CPC B03C 3/383; F24F 3/166
USPC 361/231; 29/602.1

(57) ABSTRACT

The current device and method provides an ionization system for purifying air flowing inside a duct. The system includes a transformer and a tube holder adapted for receiving an ionization tube. The tube holder is spaced from the transformer. A conduit connects the transformer to the tube holder. The replacement of the transformer in the present invention is simplified in comparison to the prior art in duct ionization systems.

### FIELD OF THE INVENTION

The present invention relates to in duct ionization systems. More specifically, the present invention relates to an in duct ionization system with a transformer that is spaced from the ionization tube.

### BACKGROUND OF THE INVENTION

Indoor air environments frequently include suspended particulates, such as dust, dander, soot and smoke particles, pollen, mold, bacteria, and viruses. Indoor gases are also present, being released from building materials, home furnishings and nondurable goods. In office environments, the greater user of machines, such as photocopying equipment and the like, is especially problematic, as this equipment may emit volatile organic compounds.

These particulates can degrade the quality of the air, making it less pleasant and even dangerous to occupants of the space. Modern construction techniques that promote energy efficiency, such as insulating walls, ceilings, doors and windows, and wrapping buildings with air intrusion barriers, have created spaces that are so airtight that the buildings are unable to off-gas toxic elements.

In ordinary heating, ventilation and cooling (HVAC) systems, air is drawn through a filter, which is intended to trap particulates in the filter. However, traditional filters are only effective for large particles of at least 10 microns in size. While high efficiency particle air (HEPA) filters are more effective, they also have disadvantages, as they may quickly become clogged, requiring frequent changing to avoid overburdening the HVAC equipment. Because of the presence of contaminants in the air and the general inability of physical filters to remove the same, a condition known as “sick building syndrome” has developed. Various building codes designed to mitigate this syndrome have been introduced; for example, the American Society of Heating, Refrigeration & Air Conditioning Engineers (ASHRAE) recommends a minimum of 8.4 air exchanges in a 24-hour period (a 35% turnover rate). While commercial and industrial facilities generally meet that minimum level, their air quality ay remain inferior. Furthermore, there are many houses that do not even meet such minimum levels. While greater turnover rates would increase the interior air quality, they would also reduce the buildings' energy efficiencies.

An alternative method to filtering involves the use of ion exchange technology to remove contaminants from air. Ionization occurs where an atom or group of atoms loses or gains one or more electrons. An electrically neutral atom or molecule will have an equal number of electrons and protons. If an electron bound to an atom or molecule absorbs enough energy from an external source, it may exceed the ionization potential and allow the electron to escape its atomic orbital. When this occurs, the electron is lost, and an ion with a positive electrical charge, a cation, is produced. Electrons that are lost become free electrons. When a free electron later collides with an atom, it may be captured within an orbital. The gain of an electron by an atom or molecule creates an ion with a negative electrical charge, an anion.

The ionization of air, e.g., air in the Earth's atmosphere, results in the ionization of the air's constituent molecules, primarily oxygen and nitrogen. While the nitrogen in air is more plentiful than oxygen, oxygen is more reactive. Thus, oxygen has a lower ionization potential than nitrogen, allowing for oxygen cations to be formed with greater ease than nitrogen cations, and oxygen has a higher electro-negativity than nitrogen, allowing for oxygen anions to be formed with greater ease than nitrogen anions.

Ionization is known to break down organic chemicals into the basic molecular constituents of water, carbon dioxide, and related metal oxides. Thus, ionization has potential for cleaning indoor air, by eliminating organic molecules and their associated odors from the enclosed environment, Ionization also contributes to the reduction of organic pollutants, by imparting a charge to those molecules, which dump together and then drop out of the air.

Studies indicate that positive ions (cations) may impair human health in a number of ways, such as by stimulating increased production of the neurohormone serotonin, which may lead to exhaustion, anxiety and depression. Positive ions are frequently found in offices where VDUs (visual display units) are used. Negative ions (anions) have a calming effect. Thus, a machine that cleans indoor air should seek to introduce negative ions into the airstream.

Under the circumstances, it would be highly desirable to use ion exchange technology for air treatment, and indeed there are many suppliers of bipolar ionization tubes that are stand alone devices used in specified locations, or centralized installations which are integrated into a building HVAC system. These devices are used in a way so that air circulated into and recirculated within the building can pass over he bipolar emitting devices, which generally take the form of an ionization tube or tubes. This would accomplish the goal of improving air quality, without mandating greater air exchange rates, Thus, an additional benefit of ionization treatment of indoor air is that it contributes to the efficiency of HVAC operations.

FIGS. 1-2 illustrate a prior art in duct ionization system (“ATMOSAIR D100”) that is sold by AtmosAir Solutions, Fairfield, Conn., http://www.atmosair.com.

FIG. 1 illustrates a perspective view of the in duct ionization system 10. The system 10 is intended to be mounted in the supply air duct (not shown) of a heating, cooling, or ventilation system (HVAC). A mounting panel 20 includes four holes 21 adapted to receive sheet metal screws (not shown) for attachment to the air duct. The system 10 includes a single bipolar ionization tube 50 and associated housing 60, The system 10 further includes an ionization level control knob 30 for adjusting the ionization Jetting, The system eludes an electrical outlet 40 for a receiving a power cord 41.

FIG. 2 illustrates a side view of the in duct ionization system 10. The ionization tube 50 includes a threaded stud (not shown) that extends from a connecting portion 51 of the ionization tube. The threaded stud of the ionization tube 50 engages with a threaded opening in the housing 60 for securing the ionization tube 50. An electrical wire 70 provides electrical power to the ionization tube 50.

In the above prior art system 10, the ionization tube 50 is attached directly to the transformer. Transformers are known to be relatively big, heavy, expensive, and prone to failure over time. It is difficult to replace a transformer in the prior art system 10 because of its arrangement.

Therefore, there is a need in the art for an improved, more efficient in duct ionization system which can be better adapted for servicing and replacing the associate transformer.

### SUMMARY OF THE DISCLOSURE

The current device and method provides an ionization system for purifying air flowing inside a duct. The system includes a transformer and a tube holder adapted for receiving an ionization tube. The tube holder is spaced from the transformer. A conduit connects the transformer to the tube holder.

### BRIEF DESCRIPTION OF THE DRAWINGS

A more complete understanding of the present device and method can be derived by referring to the detailed description when considered in connection with the following illustrative figures. In the figures. like reference numbers refer to like elements or acts throughout the figures.

FIG. 1 is a right perspective view of an ionization system in the prior art;

FIG. 2 is a right side view of the ionization system of FIG. 1;

FIG. 3 is a top view of a cover of an ionization system of the present invention;

FIG. 4 is a right side view of the ionization system of FIG. 3; and

FIG. 5 is a top view of the panel of the ionization system of FIG. 3.

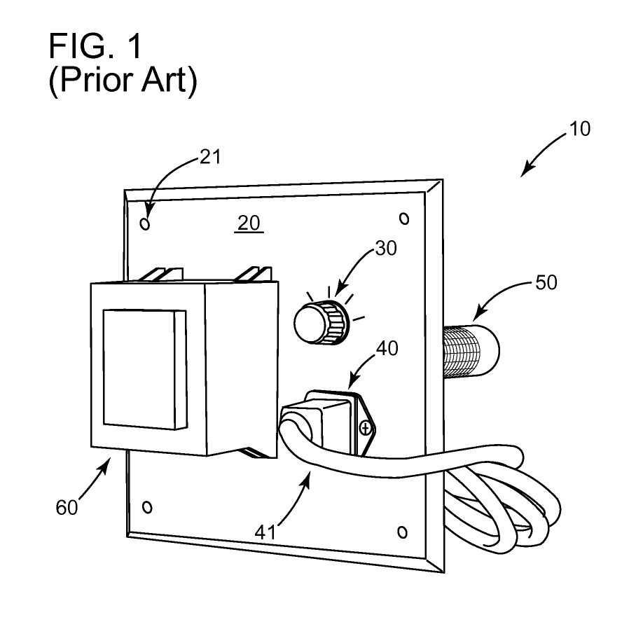

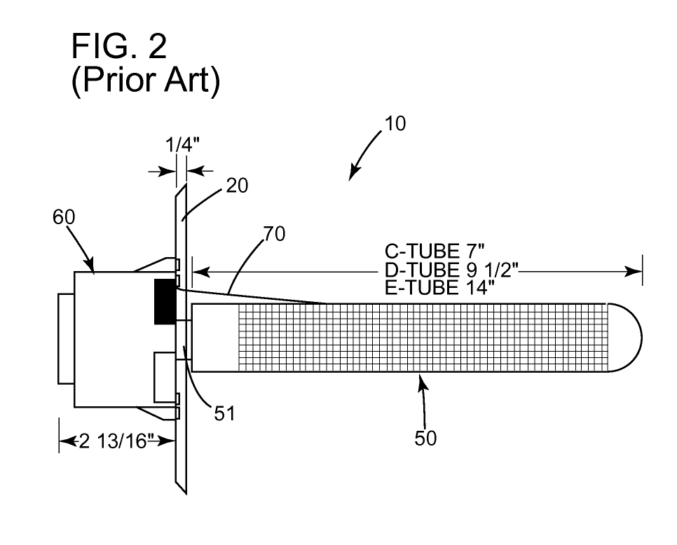

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the current device and method. It will be understood, however, by those skilled in the relevant arts, that the present device and method can be practiced without these specific details. In other instances, known structures and devices are shown or discussed more generally in order to avoid obscuring the present device and method. In many cases, a description of the operation is sufficient to enable one to implement the various forms of the device and method. It should be noted that there are many different and alternative configurations, devices and technologies to which the disclosed device and method can be applied. The full scope of the device and method is not limited to the examples that are described below.

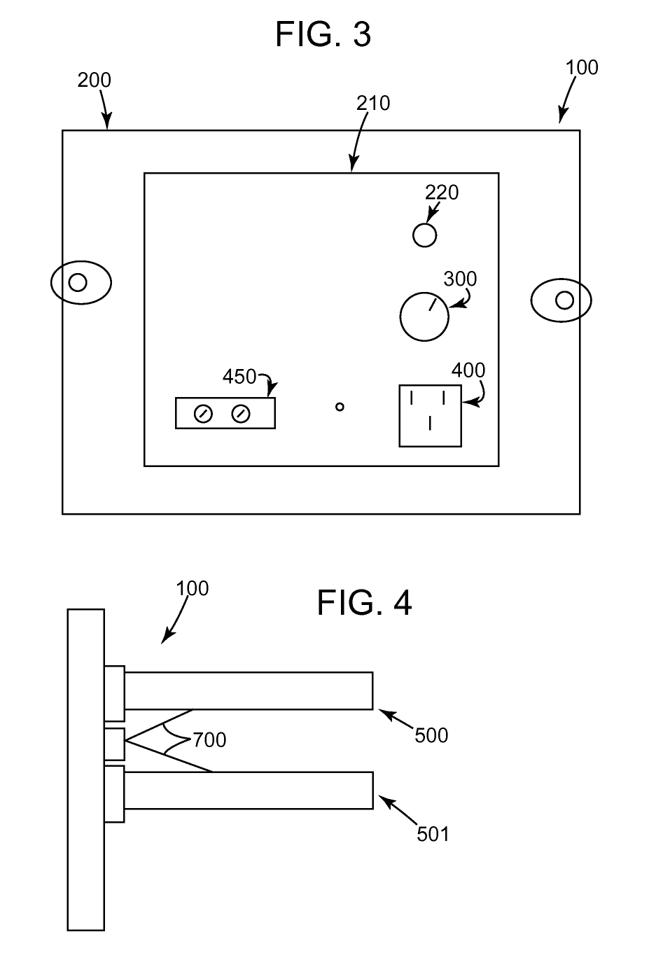

FIGS. 3-5 illustrates a first embodiment of the in duct ionization system 100 of the present invention. The system 100 is intended to be mounted in the supply air duct (not shown) of a heating, cooling, or ventilation system (HVAC).

FIG. 3 illustrates a top view of a panel 200 adapted to be mounted on the air duct. A separate cover 210 is mounted on the panel 200 for covering the internal components of the system which are illustrated in FIG. 5. The cover 210 houses an ionization level control knob 300 for adjusting the ionization setting. The cover 210 includes an electrical outlet 400 for a receiving a power cord (not shown). The cover 210 includes a power indicator 220 and a BMS connection 450, which can be used in a commercial application for monitoring the system.

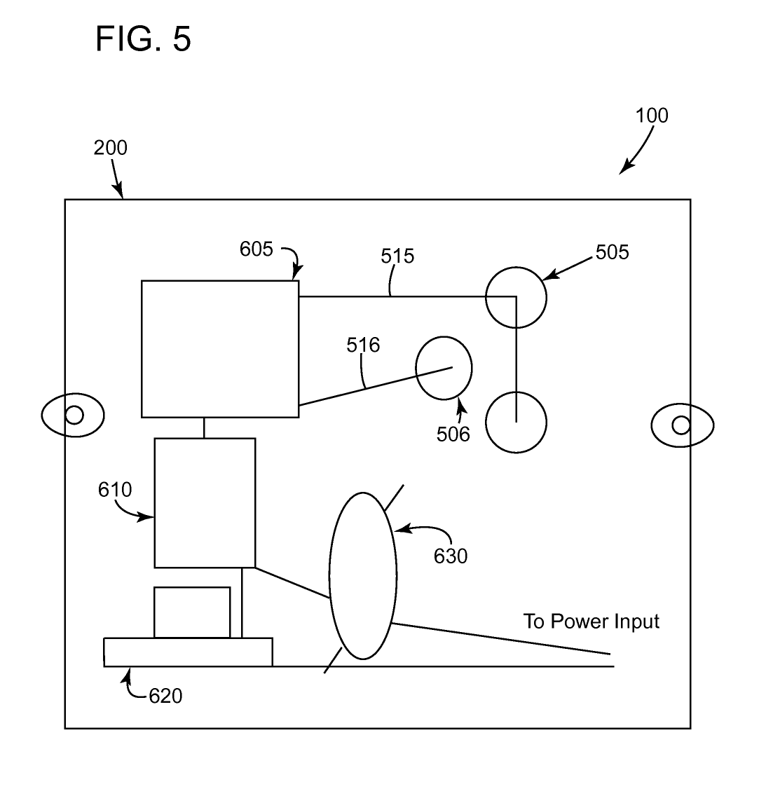

FIG. 4 illustrates a right side view of the system. The system 100 includes two bipolar ionization tubes 500, 501 which are releasably engaged with the inside surface of the panel 200. The ionization tubes 500, 501 are positioned inside the duct when the panel 200 is secured to the air duct. The ionization tubes 500, 501 include a threaded stud (not shown) that extends from a connecting portion of the ionization tube. The threaded studs of the ionization tubes 500, 501 engage with a threaded tube holder 505, 506 (see FIG. 5) for securing the ionization tubes.

FIG. 5 illustrates a top view of the panel 200, but with the cover 210 (as shown in FIG. 3) removed. A transformer 605 is mounted on the panel 200. Two tube holders 505, 506 are mounted on the panel 200 and are spaced from the transformer 605. The tube holders 505, 506 are adapted to receive two ionization tubes 500, 501 (as shown in FIG. 4). The tube holders 505, 506 are connected to the transformer via conduits 515, 516. A PC board 610 and relay with base 620 are mounted on the panel 200. An air pressure switch 630 is also mounted on the panel 200, which can be used for controlling the air flow within the duct.

A method for replacing a transformer of an in duct ionization system with a new transformer includes the following steps. The conduits 515, 516 are disconnected from the transformer 605. The transformer 605 is removed from the panel 200. A new transformer (not shown) is secured to the panel 200. The conduits 515, 516 are connected to the new transformer.

Because the transformer is spaced from the ionization tube and is separated therefrom, the present invention provides the following advantages over the prior art:

1. Any heat build up by the ionization tube is less likely to affect the transformer.

2. If the transformer needs to be replaced, it can be replaced as a standalone unit as described above.

3. The transformer can easily be replaced with an alternative source.

The above disclosure is intended to be illustrative and not exhaustive. This description will suggest many modifications, variations, and alternatives may be made by ordinary skill in this art without departing from the scope of the device and method. Those familiar with the art may recognize other equivalents to the specific embodiments described herein. Accordingly, the scope of the device and method described herein is not limited to the foregoing specification.

What is claimed is:

1. An ionization system for purifying air flowing inside a duct comprising:
a transformer;
a tube holder adapted for receiving an ionization tube, wherein the tube holder is spaced from the transformer; and
a conduit for connecting the transformer to the tube holder.

2. The ionization system of claim 1, further comprising a second tube holder for receiving a second ionization tube, wherein the second tube holder is spaced from the transformer.

3. The ionization system of claim 1, further comprising an air pressure switch for controlling the air flow within the duct.

4. A method for replacing a transformer of an in duct ionization system with a new transformer comprising:
disconnecting one or more conduits from the transformer;
removing the transformer from a panel;
securing a new transformer to the panel;
connecting the one or more conduits to the new transformer.
